(19) United States
(12) Patent Application Publication
(10) Pub. No.: US 2015/0151479 A1
(43) Pub. Date: Jun. 4, 2015

(54) METHOD FOR SEALING COOLING CHANNELS OF A DRINK PACKAGING MACHINE

(71) Applicant: KRONES AG, Neutraubling (DE)

(72) Inventors: Michael Neubauer, Obersee (DE); Anton Hirschberger, Brennberg (DE)

(21) Appl. No.: 14/406,862

(22) PCT Filed: May 8, 2013
(86) PCT No.: PCT/EP2013/059654

§ 371 Date: Dec. 10, 2014

(30) Foreign Application Priority Data
Jun. 14, 2012 (DE) 10 2012 209 969.7

(51) Int. Cl. B29C 49/48

(52) U.S. Cl. CPC B29C 49/4823; B29C 2049/4825; B29C 2049/4897; B29L 2031/7158

(57) ABSTRACT

A method for producing a drink packaging machine, including sealing at least one cooling channel in the aseptic region of a drink packaging machine, a plug being installed on the cooling channel in a fluid-sealing manner and the plug being friction stir welded to the material forming the cooling channel. Further, a mold shell of a drink packaging machine having a cooling channel which has a plug inserted therein, where the plug is also friction stir welded to the material surrounding the cooling channel. Also, a drink packaging machine, such as a stretch blow molding machine, produced in accordance with the method and/or including such a mold shell.

### CROSS-REFERENCE TO RELATED APPLICATION

The present application is the United States national phase of International Patent Application No. PCT/EP2013/059654, filed May 8, 2013, which application claims to German Application No. 10 2012 209 969.7, filed Jun. 14, 2012. The priority application is hereby incorporated by reference.

### FIELD OF THE DISCLOSURE

The present disclosure relates to a method for producing a drink packaging machine, with at least one cooling channel sealed in the aseptic region of a drink packaging machine, a closure stopper/plug installed on the cooling channel in a fluid-sealing manner.

### BACKGROUND

Drink packaging machines making use of mold carriers with the aid of which beverage container blanks, such as bottles, are held are already known from the prior art. Such mold carriers normally have two mold shells in which, during operation, e.g. plastic bottles are produced. For guaranteeing a consistent quality of the bottles, the mold shells must be maintained at a most constant possible temperature by means of a cooling fluid, e.g. a cooling liquid. To this end, the mold carrier normally has formed therein a plurality of channels, e.g. cooling channels which are configured as deep holes and through which the cooling liquid flows.

For obtaining a liquid circuit, the deep holes are interconnected via various channels. The cooling channels, connection channels and connection holes must be sealed on the outer side of the respective component so as to prevent an escape of fluid at undesired locations. To this end, so-called plugs are used. The plugs then seal the outlets of said channels to the outside, i.e. in the direction of the outer side of the component. At present, said channels are sealed e.g. by headless screws or other components, such as plates.

Such drink packaging machines must satisfy high requirements with respect to hygiene and cleanliness. Drink packaging machines comprise e.g. regions, which are also referred to as aseptic regions, where these high demands on hygiene and cleanliness have to be satisfied.

Using the above-mentioned headless screws in drink packaging machines is common practice, but these headless screws are disadvantageous insofar as their production is comparatively cost-intensive and also insofar as the cooling channel must be prepared to have the headless screws screwed in. The production must take place in a sufficiently precise manner, and this entails substantial costs. The use of individual plates does not represent an optimum solution either, since leakage may occur, a phenomenon which, however, should be avoided. Also the use of sealing solutions utilizing phase transitions, e.g. in the case of welding, is disadvantageous, since such phase transitions always entail changes in microstructure, another phenomenon that is to be avoided. In addition, the known sealing methods are normally disadvantageous insofar as they create a surface which exhibits high roughness and cracks, undercuts, etc. and which can only be kept clean with difficulties.

### SUMMARY OF THE DISCLOSURE

One aspect of the present disclosure to provide an improvement in the sphere of drink packaging machines and to eliminate the drawbacks entailed by the prior art.

A method for sealing a cooling channel in connection with the production of drink packaging machines is disclosed, which creates a very smooth, aseptic surface that is suitable for use in the food industry and that can easily be kept clean.

According to the present disclosure, this aspect is achieved in that the plug is friction stir welded to the material forming the cooling channel. The method is suitable for the dry section as well as for the wet section, where a particularly large amount of material that is difficult to weld, such as aluminum, plastic material or metal-plastic compounds, is used.

Friction stir welding offers the advantage that problems, such as hot crack problems and pore formation, occurring during phase transition in the case of fusion welding of aluminum alloys are now avoided due to the absence of a liquid or vaporous phase.

It is true that friction stir welding as such is already known in the prior art, but in a completely different technical field, e.g. in the field of seat mounting rails for airliners or in the production of machine housings for electrical machines, such as stator carriers, which are not related to food in any way. This kind of use is disclosed e.g. in DE 10 2006 035 697 A1 and DE 10 2009 010 404 A2.

It will e.g. be of advantage when the material is a metal alloy, such as an aluminum alloy, or a plastic material.

In addition, it will be of advantage when the plug is composed of metal, such as an aluminum alloy, or of a plastic material. On the one hand, it is always possible to combine like materials to one another, but it is possible to join aluminum to plastic by means of friction stir welding, which will provide an increased number of design possibilities.

When the drink packaging machine is configured as a blow molding machine, such as a stretch blow molding machine, wherein the cooling channel, which may also be configured as a deep hole, is comprised in at least one of preferably two mold shells forming together a mold carrier in which beverage container blanks are subjected to further processing, fail-proof and efficient devices can be used.

In addition, it will be of advantage when the cooling channel is drilled, in particular in the form of a through hole, blind hole or deep hole. The production of the respective channels is thus simplified. In order to guarantee a liquid circuit, it will also be of advantage when a plurality of cooling channels is formed, which are preferably in fluid-conducting communication with one another.

The production method can be executed in a particularly interruption-free manner, when the plug is first inserted into the cooling channel and then friction stir welded.

In addition, it will be expedient when the plug is friction stir welded in one end of the cooling channel such that it is flush and planar with the outer surface of the material surrounding the cooling channel. Such friction stir welding need not be executed exclusively on special purpose machines, but it can also be executed on conventional CNC processing centers or industrial robots whereby costs are reduced.

The present disclosure also relates to a mold shell of a drink packaging machine comprising a cooling channel which has a plug inserted therein, the plug being friction stir welded to the material surrounding the cooling channel.

In addition, the disclosure relates to a drink packaging machine, such as a stretch blow molding machine, produced in accordance with the method according to the present disclosure and/or including a mold shell according to the present disclosure.

### BRIEF DESCRIPTION OF THE DRAWINGS

The disclosure is described in more detail also with the aid of a drawing, in which:

FIG. 1 shows a perspective, first view of a mold shell of a mold carrier used in a drink packaging machine, such as a stretch blow molding machine, and

FIG. 2 and FIG. 3 show, in two different perspectives, friction stir welding of a plug inserted into a cooling channel of the mold shell according to FIG. 1.

The drawings are only of a schematic nature and they only serve to make the present disclosure understandable. Like elements are designated by like reference numerals.

### DETAILED DESCRIPTION

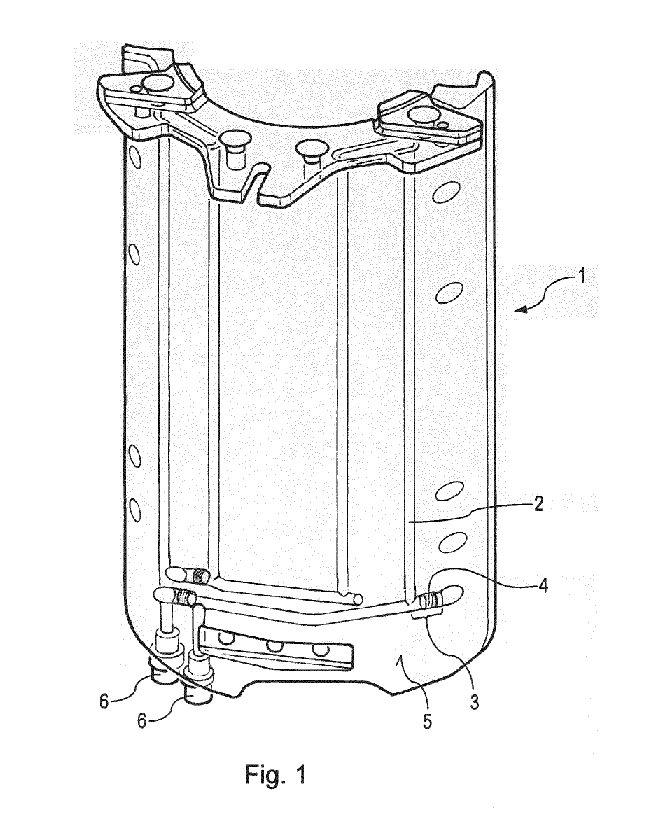

FIG. 1 shows a mold shell 1 configured as part of a mold carrier in a drink packaging machine according to the present disclosure. The mold shell 1 has formed therein cooling channels 2. Individual cooling channels 2 serve as connection channels. The cooling channels 2 are, by means of deep holes, incorporated from outside into the material of the mold shell 1. The ends 3 of a respective cooling channel 2 have each inserted therein a plug 4 in a fluid-sealing manner.

The plug 4 thus prevents a cooling fluid, e.g. a cooling liquid, from flowing out of the interior of the mold shell 1 onto the surface 5 of the mold shell 1, i.e. to the outside thereof. The cooling liquid can only flow out at feed and discharge lines 6, which are provided for this purpose.

The mold shell 1 normally consists of an aluminum alloy or of a plastic material. Also the plug 4 consists of an aluminum alloy, a plastic material, steel or stainless steel.

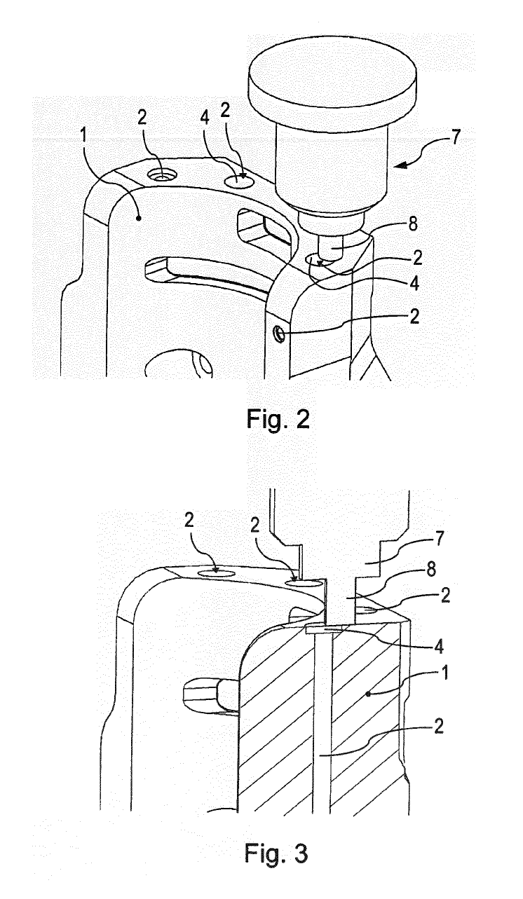

The plug 4 need not necessarily be flush with the surface 5 of the mold shell 1, as shown in the embodiment according to FIG. 1, a flush mode of arrangement being, however, preferred, cf. FIGS. 2 and 3.

FIGS. 2 and 3 show a detail representation of an upper end of the mold shell 1, which has cooling channels 2 comprised therein. A friction stir head 7 of a friction stir welder acts here weldingly onto a plug 4. A rotating pin is here immersed into the material, whereupon it moves along the joint edges and “stirs” the materials of the two join parts such that a solid connection is created. A pinlike component of the friction stir head 7 is here designated by reference numeral 8.

The method according to the present disclosure has a plurality of advantages, viz. the avoidance of phase transition in the material of the plug 4 or of the mold shell 1 when these components are joined by welding allows a high reproducible quality of the seam, prevents pore formation, causes an only low tendency towards weld residual stresses and allows thus the production of components with little distortion.

No special preparations for the seam, such as degreasing, are required. The use of filler materials or auxiliaries, such as gases or powders, can be dispensed with. A comparatively low power consumption in combination with high efficiency is obtained. Especially in the case of full penetration welding in an I-joint down to 20 mm in one layer, perfect quality will be obtained. Even aluminum alloys which are not suitable for fusion welding can be processed. Also dissimilar materials to be joined can easily be processed.

1. A method for producing a drink packaging machine, comprising:
at least one cooling channel is sealed in the aseptic region of a drink packaging machine, and
a plug installed on the cooling channel in a fluid-sealing manner the plug being friction stir welded to the material forming the cooling channel.

2. The method according to claim 1, the material is a metal alloy, a plastic material, steel or stainless steel.

3. The method according to claim 1, and the plug is composed of metal or of a plastic material.

4. The method according to claim 1, and the drink packaging machine is configured as a blow molding machine, and the cooling channel is comprised in at least one of at least two mold shells forming together a mold carrier in which beverage container blanks are subjected to further processing.

5. The method according to claim 1, and the cooling channel is drilled.

6. The method according to claim 1, and a plurality of cooling channels is formed.

7. The method according to claim 1, and the plug is first inserted into a cooling channel and then friction stir welded.

8. The method according to claim 7, and the plug is friction stir welded in one end of the cooling channel such that the plug is flush and planar with the outer surface of the material surrounding the cooling channel.

9. A mold shell of a drink packaging machine, comprising a cooling channel which has a plug inserted therein, the plug being friction stir welded to the material surrounding the cooling channel.

10. A drink packaging machine produced in accordance with the method according to claim 1.

11. The method according to claim 2, and the metal alloy comprises an aluminum alloy.

12. The method according to claim 3, and the metal alloy comprises an aluminum alloy.

13. The method according to claim 4, and the blow molding machine comprises a stretch blow molding machine.

14. The method according to claim 5, and the drilled cooling channel is in the form of a through hole, a blind hole, or a deep hole.

15. The method according to claim 6, and the plurality of cooling channels being in fluid-conducting communication with one another.

16. The drink packaging machine according to claim 10, and the drink packaging machine comprising a stretch blow molding machine.

17. A drink packaging machine produced in accordance with claim 9.

18. The drink packaging machine according to claim 17, and the drink packaging machine comprising a stretch blow molding machine.
